(19) United States
(12) Patent Application Publication
(10) Pub. No.: US 2024/0224949 A1
(43) Pub. Date: Jul. 11, 2024

(54) Hyper-realistic hummingbird feeder

(71) Applicant: Madison Giles, Sunnyvale, CA (US)

(72) Inventor: Madison Giles, Sunnyvale, CA (US)

(21) Appl. No.: 18/402,610

(22) Filed: Jan. 2, 2024

Related U.S. Application Data
(60) Provisional application No. 63/436,838, filed on Jan. 3, 2023.

(51) Int. Cl. A01K 39/02

(52) U.S. Cl. CPC A01K 39/0206

(57) ABSTRACT

A hyper-realistic hummingbird feeder with unique features replicating the natural characteristics of Passiflora vitifolia (red passionflower), such as artificial flowers and leaves that mimic Passiflora vitifolia in color and flexibility that are attached to and around the feeding ports, and the lack of a stable perch that allows hummingbirds to hover while feeding at flowers, which is consistent with natural hummingbird feeding behaviors. Additional features include a removable lid to which the artificial flowers and leaves are attached to, a clear nectar basin that can be easily refilled by the user(s), an insect moat to prevent nectar contamination, and a visible metal hook to hang the feeder from for easy access for both the birds and user(s).

### BACKGROUND OF THE INVENTION

### 1. Field of Invention

The present invention relates to the field of hummingbird feeders with feeding ports with flowers made of foam materials to mimic real and natural flowers.

### 2. Description of Prior Art

There is no hummingbird feeder with a flat lid with three feeding ports that mimics real and natural flowers with a nectar holding base and no perching mechanism.

There are several prior art that the present inventor is aware of and they are:
U.S. Pat. No. 382,376 issued on Aug. 12, 1997 to Robert E. Bescherer for “HUMMINGBIRD FEEDER” contains the flower is two-dimensional and is molded as part of the top lid.
U.S. Pat. No. 5,454,348 issued on Oct. 3, 1995 to Colwell et al. for “HUMMINGBIRD FEEDER”
U.S. Pat. No. 8,763,556 issued on Jul. 1, 2014 to William R. Vaughn, Jr. for “SOFT PETAL FLOWER PORT FOR HUMMINGBIRD FEEDERS”
U.S. Pat. No. D454,669 issued on Mar. 19, 2002 to Robert Paul Lieb for “HUMMINGBIRD FEEDER” contains three-dimensional hard plastic ornamental flowers.
   While these prior art related to the field of the present invention, they are not suitable nor have unique features of the present invention.

### SUMMARY OF THE INVENTION

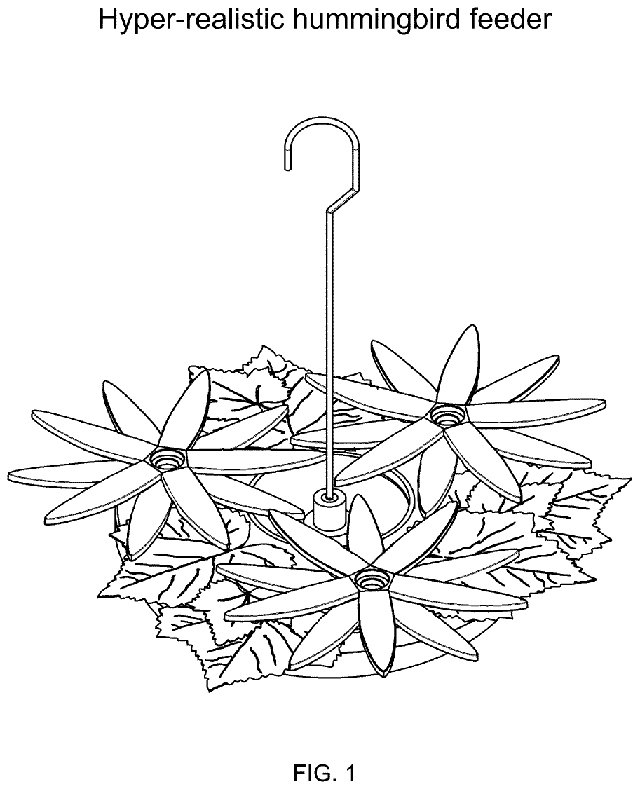

The hyper-realistic hummingbird feeder invention mimics natural red passion flowers (Passiflora vitifolia) promoting natural feeding behaviors (FIG. 1) by creating flowers with feeder ports that replicate natural Passiflora vitifolia and minimize the ability for the hummingbirds to perch while feeding.

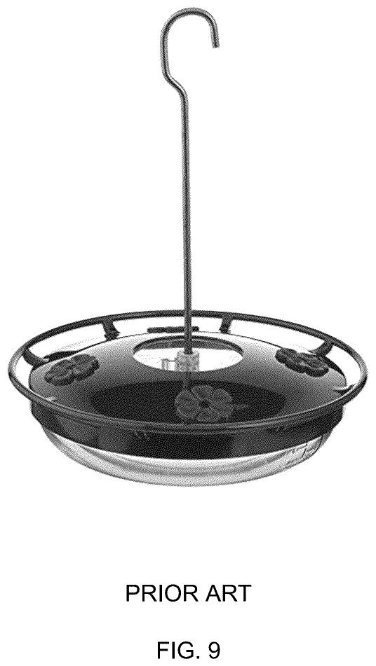

The hyper-realistic hummingbird feeder has two main unique features that promote natural feeding behaviors, artificial flowers and leaves that mimic natural flowers and no built-in perch such as commonly found in many commercial feeders or prior art (FIG. 9).

Additional features of the hyper-realistic hummingbird feeder include a base that holds nectar that hummingbirds can consume with an insect trap preventing insects from consuming and contaminating the nectar, a hook by which the feeder can be hung from a branch or other suitable object that allows hummingbird safe and easy access to the feeder.

The hyper-realistic hummingbird feeder is easy to refill and clean, so it can be cleaned more frequently to minimize bacterial growth that may harm the hummingbirds.

### BRIEF DESCRIPTION OF THE INVENTION

The drawings are for illustration only of the features, but do not limit the spirit or intent of the hyper-realistic hummingbird feeder design. Throughout these drawings the example flowers shown are Passiflora vitifolia (passion flowers) for illustration only.

FIG. 1 is an isometric view of the completed present invention of a hyper-realistic hummingbird feeder fully assembled;

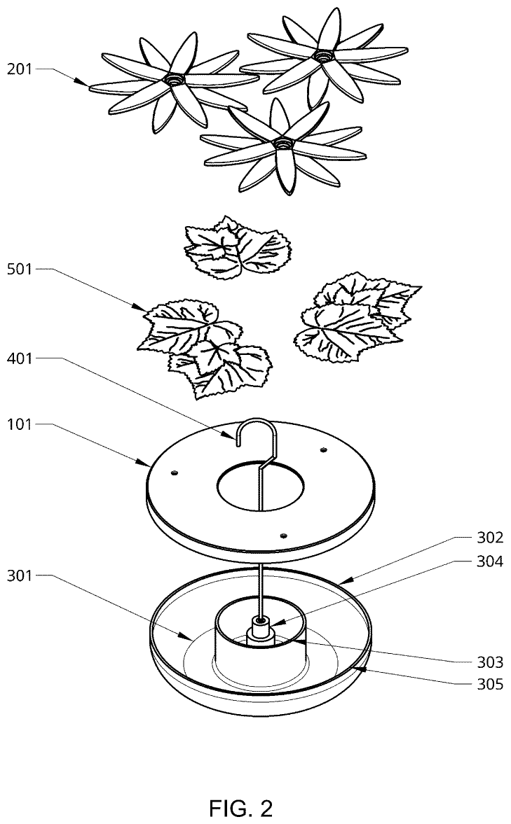

FIG. 2 is an exploded view of the hyper-realistic hummingbird feeder including the flat lid without perching mechanism, including three feeding ports with artificial passion flowers, the nectar holding base so that the hyper-realistic hummingbird feeder can be affixed to a tree or other object;

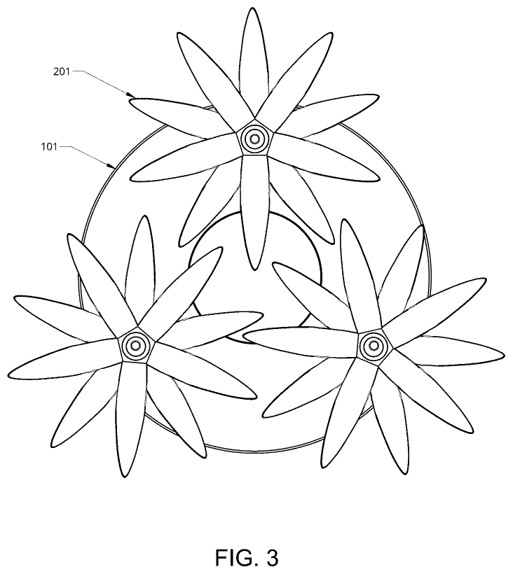

FIG. 3 is a top view of an hyper-realistic hummingbird feeder flat lid for the nectar holding base with three feeding ports and artificial passion flowers

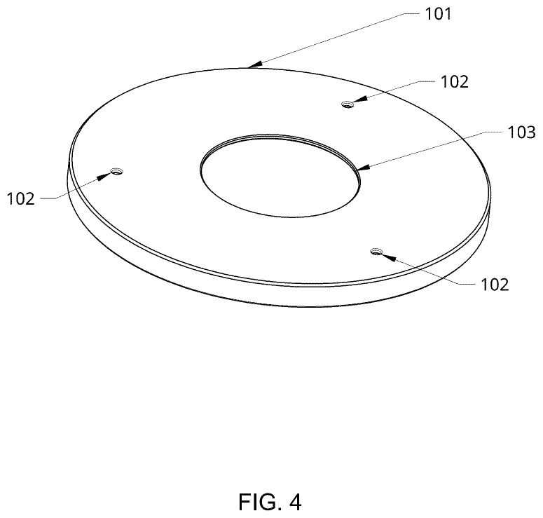

FIG. 4 is an isometric view of the hyper-realistic hummingbird feeder flat lid for the nectar holding base with three feeding ports without perching mechanism;

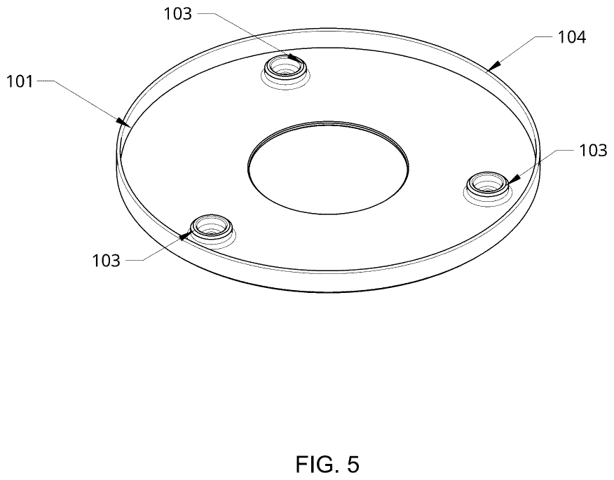

FIG. 5 is an isometric view of the underside of the hyper-realistic hummingbird feeder flat lid for the nectar holding base with three feeding ports without perching mechanism;

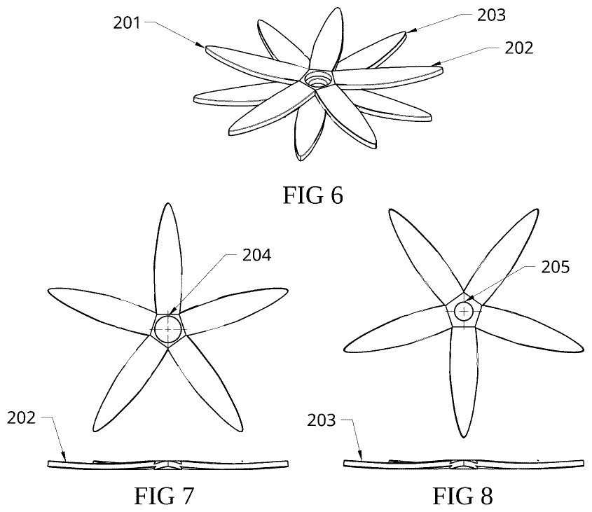

FIG. 6 is isometric view of the assembled artificial passion flowers (Passiflora vitifolia)

FIG. 7 is a top and side view of one set of petals of the artificial passion flower

FIG. 8 is a top and side view of one set of petals of the artificial passion flower

FIG. 9 Prior art—hummingbird feeder with removable lid, hard plastic molded flowers, more than 3 feeding ports and perch.

### DETAILED DESCRIPTION OF THE DRAWINGS

Although specific implementations of the present invention will be explained with reference to the drawings, it should be noted that these illustrations are simply examples of the various ways the principles of the present invention can be applied.

Referring to FIG. 1 is an isometric view of the completed present invention of a hyper-realistic hummingbird feeder fully assembled.

Referring to FIG. 2, an is an exploded view of the hyper-realistic hummingbird feeder that shows the components of the hyper-realistic hummingbird feeder. The artificial Passiflora vitifolia flower 201 and leaves 501, that are attached to the hummingbird feeder lid 101 during production. The lid fits onto the hummingbird feeder base 302. The base has a reservoir 301 to hold nectar, this has a surrounding lip 305 which goes into the corresponding lip on the lid, securing the lid to the base and allowing for easy removal for cleaning and refilling. The base has a second reservoir 303 acting as an insect prevention moat to prevent crawling insects from accessing the nectar.

In the center of the base a threaded receptacle 304 allows a hanging rod 401 to be attached to the base so the complete hummingbird feeder can be hung from a suitable object.

In addition the hanging rod is surrounded by the moat 303 so crawling insects descending the hanging rod cannot crawl onto the lid and access the nectar through the feeding ports.

Referring to FIG. 3 which is a top view of an assembled hyper-realistic hummingbird feeder flat lid 101 for the nectar holding base with three feeding ports and artificial passion flowers 201.

Referring to FIG. 4 an isometric view of the hyper-realistic hummingbird feeder flat lid 101, allows for flowers and other items mimicking the natural environment to be easily attached. In addition the flat lid minimizes the distance between the feeding port and the nectar. The minimal distance is consistent irrespective of the number or location of feeding ports on the lid. The feeding ports 102 are typically spaced equally around the lid. The feeding ports should be a shape and diameter that eliminates nectar access to flying insects and can be varied as needed. The central opening of the lid 103 allows the insect prevention moat of the base to pass through the lid. The lid is typically made of transparent plastic allowing for easy viewing of the nectar levels when in use.

Referring to FIG. 5, an isometric view of the underside of the hyper-realistic hummingbird feeder flat lid 101 shows the feeding port chamber 103 mimicking the nectar chamber formed by the petals in a Passiflora vitifolia flower. The underside of the lid has a rim (4) which is greater than the diameter of the base, allowing the lid to be placed over the base and fit securely. Typically the lid is made of plastic in a color mimicking the natural environment. The lip 104 allows the lid to fit securely over the corresponding lip of the base 305.

Referring to FIG. 6 the flowers 201 are designed to mimic a Passiflora vitifolia. The Passiflora vitifolia reproduction was made in two parts 202, 203 then attached together with glue and glued to the lid with a suitable adhesive. The reproduction flower is typically made from a flexible material such as craft foam that is stiff enough to retain a curved petal shape 202, 203 as shown in FIGS. 7 & 8, yet flexible enough to mimic a natural flower and importantly not easily hold the weight of a hummingbird, therefore not offering a place to perch while feeding. To provide easy access and allow for cleaning each petal has different size holes 204, 205 that when attached to the lid provide access to the feeding ports 102.

I claim a hyper-realistic hummingbird feeder comprising:

1. A circular clear basin serves as a base and connection point for all subsequent parts. The basin has an inner ring and outer ring that contain liquid. The outer ring is a nectar retaining basin, which encompasses an inner ring and is a water retaining basin. In the center of the inner ring is a connection point for the pole.

2. A pole affixed to the center of the circular clear basin including a shaft extending through a central opening. The pole ends in a hook at the top.

3. A cover that attaches to the base by means of an interlocking lip, and overlaps the base. The outside edge of the cover extends over the nectar retaining basin, and the inner edge partially over the moat. Sufficient distance is maintained between the inner edge of the cover and the pole such that crawling insects cannot easily reach across the pole and inner edge of the cover and gain access to the nectar. The cover also has equidistance ports, providing access to the nectar.

4. Each port is equidistant from each other, and equidistant between the each edge of the nectar retaining basin. The ports are of sufficient diameter to allow a hummingbird easy access to the nectar, and small enough to prevent access to many other flying insects.

5. The flowers are designed to mimic naturally occurring flowers, both in color, flexibility, outline shape and contour, and constructed from a suitable material to mimic that or a natural flower. Each flower has a central hole, 3-4× the diameter of the port. The assembled flower is affixed onto the cover, centrally over a port.

6. Leaves are designed to mimic the natural flora, and constructed from a suitable material to mimic that or a natural leaf. The leaves affixed over the cover but not the feeding ports and without compromising the integrity of the central opening or covering the flowers.
